(19) United States
(12) Patent Application Publication
(10) Pub. No.: US 2004/0264545 A1
(43) Pub. Date: Dec. 30, 2004

(54) Fast response probe for a food thermometer

(76) Inventor: Richard Rund, Great Falls, VA (US)

Correspondence Address: CAHN & SAMUELS LLP, 2000 P STREET NW, SUITE 200, WASHINGTON, DC, 20036, US

(21) Appl. No.: 10/815,991

(22) Filed: Apr. 2, 2004

Related U.S. Application Data
(60) Provisional application No. 60/459,256, filed on Apr. 2, 2003.

(51) Int. Cl. G01K 1/00

(52) U.S. Cl. 374/208

(57) ABSTRACT

The invention preferably is fast response probe for a food thermometer. The prove preferably has a distal end and a proximal end, the proximal end including an opening; a temperature sensing element disposed in said probe housing proximate to the opening; and a thermally conductive food safe coating covering the opening.

This application claims the benefit of Provisional Patent Application No. 60/459,256, filed Apr. 2, 2003.

### I. FIELD OF THE INVENTION

This invention relates generally to temperature probes and, more particularly, to a temperature probe for use in with digital food thermometers.

### II. BACKGROUND OF THE INVENTION

Accurate, reliable and instantaneous sensing and measuring the temperature of food items is critically important. The most accurate and expedient manner in which to measure the temperature of a food item is by inserting a temperature-sensing device into the food item. A commonly used device is a digital thermometer.

It is very important to thoroughly clean the thermometer probe after each use. If food particles become lodged in the probe, food borne bacteria may develop. If the probe is not cleaned prior to its next use, those food borne bacteria could be transmitted to the food item.

Conventional digital thermometers include probes that are designed for insertion into food items. These probes are frequently fabricated from a metal such as stainless steel. An exemplary probe is disclosed in U.S. Pat. No. 3,975,720. There, 38 having a thermistor 42 disposed therein near distal end 4, as illustrated in FIG. 1. This style probe is satisfactory for some applications, but it tends to have a response time that is undesirably slow for many applications due to the separation between the thermistor and the food item.

There are known probe designs that exhibit increased response times. Exemplary probes are described in U.S. Pat. Nos. 4,133,208 and 6,000,845. The probe of the '208 patent is illustrated in FIG. 2. The probe includes a shank 24b having an open distal end. A semi-conductor temperature sensing element 41b is disposed in and protrudes through the open distal end. The ends 51 of shank 24b are swedged around semi-conductor temperature sensing element 41b and the interior of shank 24b is filled with epoxy 49b. The probe of the '845 patent is shown in FIG. 3. That probe is constructed from stainless steel and has a sensing end 28 that is inwardly tapered and has an opening 281. The probe encloses a temperature sensor 32. A temperature sensing point 324 of temperature sensor 32 protrudes partially from opening 281.

The response times of the probe of the '208 patent and the probe of the '845 patent are more rapid than those of the traditional closed end probes because, as used, the temperature sensing element makes direct contact with the food item. However, in making direct contact, food is likely to become lodged or wedged in the crevices between end portions of the probe and the temperature-sensing element making it difficult to clean the probe. Food build-up can be dangerous as it can be a haven for food borne bacteria. In addition, it is believed to be unhealthy to directly contact the food item with the temperature-sensing element.

Accordingly, there remains a need for a probe for a digital thermometer that is both food safe and has a rapid response time.

### III. SUMMARY OF THE INVENTION

It is an object of this invention to provide a thermometer probe that has a rapid response time.

It is a further object of the invention to provide a thermometer probe that is easy to clean.

It is still another object of the invention to provide a thermometer probe that minimizes transmission of food borne bacteria.

In accordance with an aspect of the invention, a thermometer probe includes a probe housing having a distal end and a proximal end and the proximal end includes an opening or cavity an opening. A temperature sensing element, preferably a thermistor, is disposed in the probe housing close to the cavity. The cavity is covered by a thermally conductive, food safe coating.

Given the following enabling description of the drawings, the apparatus should become evident to a person of ordinary skill in the art.

### IV. BRIEF DESCRIPTION OF THE DRAWINGS

FIG. 1 illustrates a prior art food thermometer.

FIG. 2 depicts another prior art probe.

FIG. 3 shows still another prior art probes.

FIG. 4 illustrates a cross-sectional view of an embodiment of a probe in accordance with the invention.

FIG. 5 depicts another embodiment of the probe of the present invention.

FIG. 6 is a response time comparison between a prior art probe and the probe of the invention.

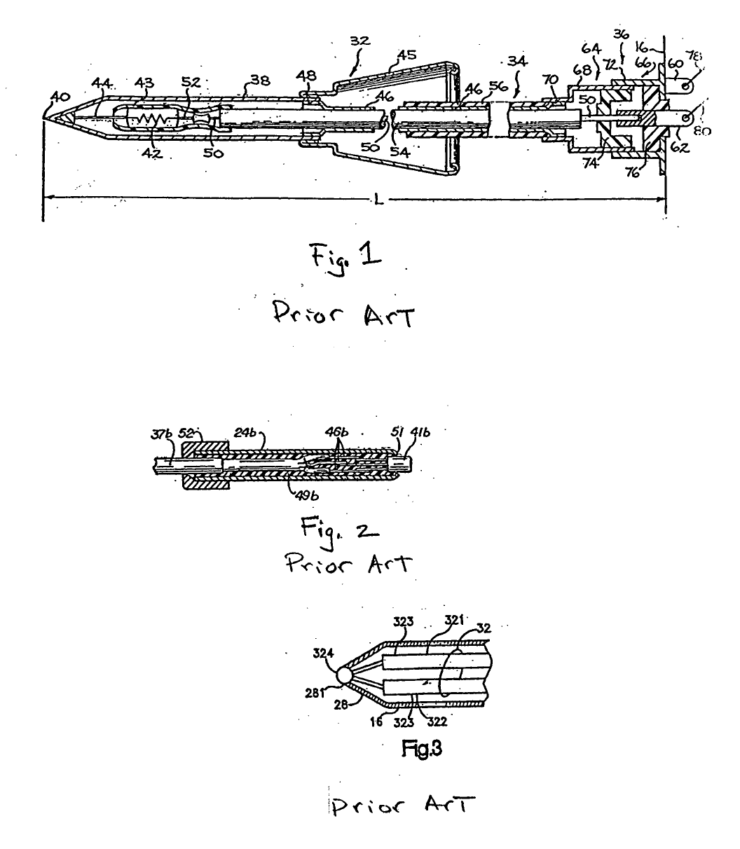

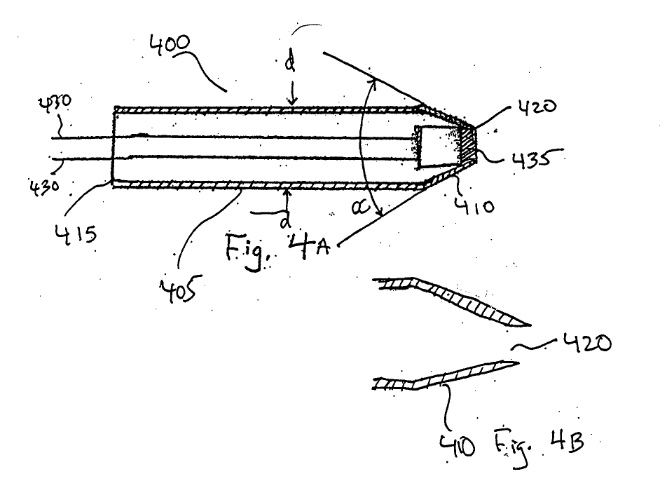

### V. DETAILED DESCRIPTION OF THE DRAWINGS

FIG. 4a shows a cross-sectional view of a probe 400 according to an embodiment of the invention. The probe 400 includes a probe housing 405 having a proximal end 410 and a distal end 415. As best shown in FIG. 4b, proximal end 410 includes an opening 420. A temperature-sensing device 425 is preferably disposed within housing 405 proximate to an opening or cavity 420. Temperature sensing device 425 includes a proximal surface and a distal surface. In addition, temperature sensor 425 may include lead wires 430, or other coupling mechanisms, that extend through probe housing 405 to couple temperature sensing device 425 to thermometer circuitry (not shown) for displaying the measured temperature. A preferred temperature-sensing device is a GT thermistor such as the 104GT thermistor available from Ishizuka Electronics Corporation (Semitec) of Tokyo, Japan.

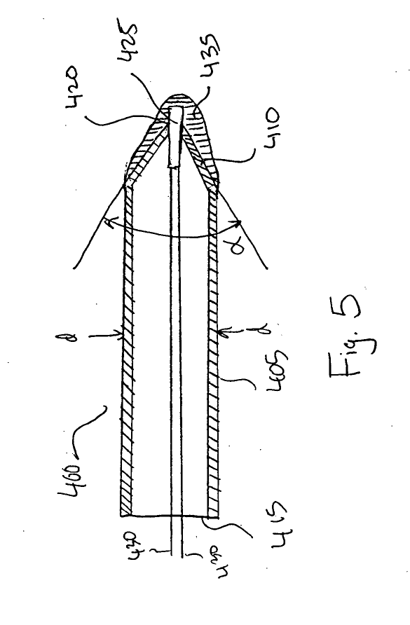

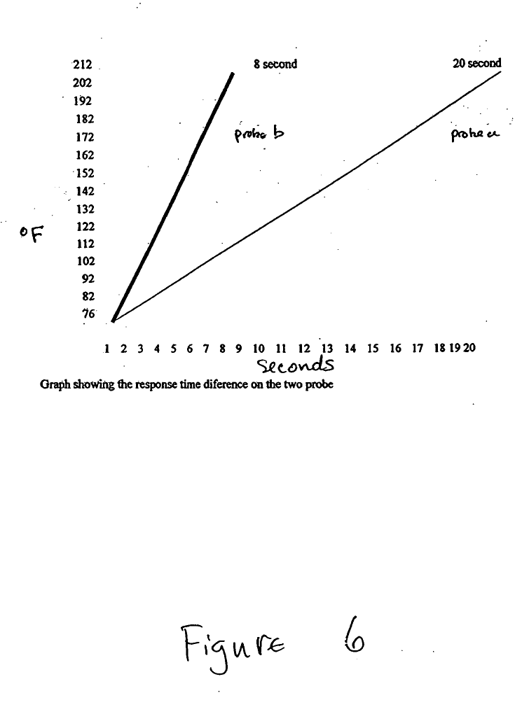

In accordance with an aspect of the invention, a thermally conductive food safe coating is applied over opening 420 to promote heat transfer from the food item and to minimize the potential of unwanted food build-up in proximal end 410. As illustrated in FIG. 4a, the opening 420 is preferably filled with coating 435. However, in some embodiments the coating may not fill the entire opening and there may be a small gap between the proximal surface of temperature sensing device 425 and coating. Alternatively, as illustrated in FIG. 5, temperature-sensing device 425 may be disposed such that it protrudes through opening 420. In this embodiment, coating 435 may cover the entire exposed surface of temperature sensing device 425 as well as the seam between temperature sensing device 425 and probe housing 405, or the entire exposed surface of temperature sensing device 425 and some or all of proximal end 410. Preferred coatings include TEFLON®, particularly polytetrafluoroethylene and fluorinated ethylene propylene copolymer, and thermoset powder coatings such as ER05-3D9 available from Pioneer Powder Products of Melrose, Park Ill.

In accordance with another aspect of the invention, proximal end 410 is preferably tapered as depicted in FIGS. 4 and 5. However, proximal end 410 may be, flat, rounded or otherwise configured to suit the user's application.

FIG. 6 illustrates a graph comparing response time of a conventional closed end probe to that of a probe according to the present invention. The response time was measured from room temperature, approximately 76° F./24° C., to the boiling point of water, 212 °/100° C. The conventional closed end probe of FIG. 6 (probe a) is comprised of SUS 304 stainless steel housing that is about 80 mm long with a diameter d of about 3.4 mm. Probe a includes a tapered proximal end having a taper angle α of about 26°. A Semitec 104GT thermistor is disposed in probe a proximate to the proximal end. Probe b of FIG. 6 is similar to probe a but further includes an opening having an inner radius of about 0.4 mm and an outer radius of about 0.5 mm. The thermistor is placed in the proximal end as close to the opening as possible. The opening was coated with TEFLON®. The response time for probe a was 20 seconds and the response time for probe was 8 seconds. Accordingly, probe b has a response time that is reduced by about 60% from the response time of probe a.

Although the present disclosure is described herein with respect to illustrative embodiments thereof, it should be appreciated that the foregoing and various other changes, omissions or additions in the form and detail thereof may be made without departing from the scope and spirit of the disclosure. It is to be understood that the described embodiments of the disclosure are illustrative only, and that modifications thereof may occur to those skilled in the art. Accordingly, this disclosure is not to be regarded as limited to the embodiments disclosed, but is to be limited only as defined by the appended claims.

We claim:

1. A probe for a food thermometer comprising:
a probe housing having a distal end and a proximal end, the proximal end including an opening;
a temperature sensing element disposed in said probe housing proximate to the opening; and
a thermally conductive food safe coating covering the opening.

2. The probe of claim 1 wherein said coating includes at least one of a polytetrafluoroethylene and fluorinated ethylene propylene copolymer.

3. The probe of claim 1 wherein said coating is a thermoset powder coating.

4. The probe of claim 1wherein the coating fills the opening.

5. The probe of claim 4 wherein the coating is substantially flush with a mouth of the opening.

6. The probe of claim 1 wherein said temperature sensing element protrudes through said opening and the coating covers the exposed portion of said temperature-sensing element.

7. The probe of claim 6 wherein the proximal end is tapered and the coating covers the tapered portion of the proximal end.

8. The probe of claim 1 wherein the coating is contiguous to the proximal surface of the temperature-sensing element.
